(19) United States
(12) Patent Application Publication
(10) Pub. No.: US 2026/0063157 A1
(43) Pub. Date: Mar. 5, 2026

(54) QUICK DISASSEMBLY AND ASSEMBLY TYPE CONNECTING STRUCTURE

(71) Applicant: GUANGDONG DERUI SMART HOME CO., LTD., FOSHAN (CN)

(72) Inventor: YESONG XIE, FOSHAN (CN)

(21) Appl. No.: 19/175,778

(22) Filed: Apr. 10, 2025

(30) Foreign Application Priority Data
Sep. 2, 2024 (CN) 202422140771.2

(51) Int. Cl. F16B 12/34

(52) U.S. Cl. CPC F16B 12/34

(57) ABSTRACT

The present disclosure relates to the technical field of hardware fittings, and in particular to a quick disassembly and assembly type connecting structure, including a quick-release pin head and a quick-release pin seat. The quick-release pin head and the quick-release pin seat are slidably arranged. A cross section of a slideway of the quick-release pin seat is of an inverted T-shaped structure. The quick-release pin head is slidably in close fit with the slideway. A mounting plate is welded and fixed to an end of the quick-release pin head. The quick-release pin head and the quick-release pin seat are slidably arranged and thus can be quickly spliced. Compared to a screw or welding mounting method, better flexibility is achieved. In the transfer of an object equipped with the quick-release structure, the quick disassembly and assembly type connecting structure can be separated for transportation, thereby reducing an occupation of space.

### TECHNICAL FIELD

The present disclosure relates to the technical field of hardware fittings, and in particular to a quick disassembly and assembly type connecting structure.

### BACKGROUND

Quick-release accessories refer to those accessories that can be quickly assembled and disassembled, and are mainly designed to enhance work efficiency, simplify assembly and disassembly processes, reduce tool dependency, and lower maintenance costs.

The quick-release accessories have the following advantages:

Efficiency and Convenience: Time required for assembly and disassembly can be remarkably shortened, thereby improving the work efficiency.

User-Friendly Operation: A user can easily perform operation, typically requiring no specialized tools.

High Universality: Many of the quick-release accessories have standardized interfaces, and thus are applicable to diverse equipment and application scenarios.

Enhanced Safety: Safety-focused designs are incorporated, thereby preventing equipment damage or personnel injury caused by improper operation.

Currently, for some sofas or chairs made of a metal material, a seat cushion and an overall frame thereof are mostly welded or fixed by screws. This design results in excessive space occupation during bulk transfer, so it is necessary to improve a connecting part, thereby designing a quick-insertion structure for the seat cushion and the frame in order to facilitate separate transportation or assembly for use.

### SUMMARY

The present disclosure aims to overcome the above defects in the prior art and thus provides a quick disassembly and assembly type connecting structure.

To achieve the above objects, the present disclosure uses the following technical solution.

A quick disassembly and assembly type connecting structure is designed, including a quick-release pin head and a quick-release pin seat, where the quick-release pin head and the quick-release pin seat are slidably arranged, a cross section of a slideway of the quick-release pin seat is of an inverted T-shaped structure, the quick-release pin head is slidably in close fit with the slideway, and a mounting plate is welded and fixed to an end of the quick-release pin head.

In detail, the quick-release pin head and the quick-release pin seat and the mounting plate are made of a stainless steel material.

In detail, a vertical opening in a front side of the slideway of the quick-release pin seat is in a shape of a conical structure.

In detail, a position, fitting a vertical opening of the slideway, of the end of the quick-release pin head is of a conical structure.

In an application process, the design solution put forwards in the present disclosure has the following beneficial effects:

1. The quick-release pin head and the quick-release pin seat are slidably arranged and thus can be quickly spliced, and can also be quickly disassembled when applied to a connection position, while ensuring stable mounting. Compared to a screw or welding mounting method, better flexibility is achieved. In the transfer of an object equipped with the quick-release structure, the quick disassembly and assembly type connecting structure can be separated for transportation, thereby reducing an occupation of space.

### BRIEF DESCRIPTION OF FIGURES

FIG. 1 is a schematic diagram of a top view structure of a quick-release pin head and a quick-release pin seat of the present disclosure;

FIG. 2 is a schematic diagram of a shape of a notch of the quick-release pin seat of the present disclosure;

FIG. 3 is a schematic diagram of a shape of an end of the quick-release pin head of the present disclosure;

FIG. 4 is a schematic diagram of the quick-release pin head and the quick-release pin seat of the present disclosure mounted on a chair;

FIG. 5 is a schematic bottom-up view of FIG. 4 of the present disclosure;

FIG. 6 is an enlarged schematic diagram of part a in FIG. 5 of the present disclosure;

FIG. 7 is a schematic diagram of the quick-release pin head and the quick-release pin seat of the present disclosure mounted on a sofa;

FIG. 8 is a schematic bottom-up view of FIG. 7 of the present disclosure;

FIG. 9 is a schematic diagram of an overall structure of the present disclosure;

FIG. 10 is a schematic diagram of a top view dimension of the present disclosure;

FIG. 11 is a schematic diagram of a front view dimension of the present disclosure; and

FIG. 12 is a schematic diagram of a side view dimension of the present disclosure.

In the drawings: 10, quick-release pin head; 11, quick-release pin seat; 12, mounting plate; 20, first leg frame; 21, first leg vertical bar; 22, first leg cross bar; 23, first backrest plate; 24, first hip frame; 25, first hip cross plate; 30, second leg frame; 31, second leg vertical bar; 32, second leg cross bar; 33, second backrest plate; 34, second hip frame; 35, second hip cross bar; and 36, hip longitudinal bar.

### DETAILED DESCRIPTION

The technical solutions in embodiments of the present disclosure will be clearly and completely described below with reference to the drawings in the embodiments of the present disclosure. Apparently, the described embodiments are merely some rather than all of the embodiments of the present disclosure.

### Embodiment I

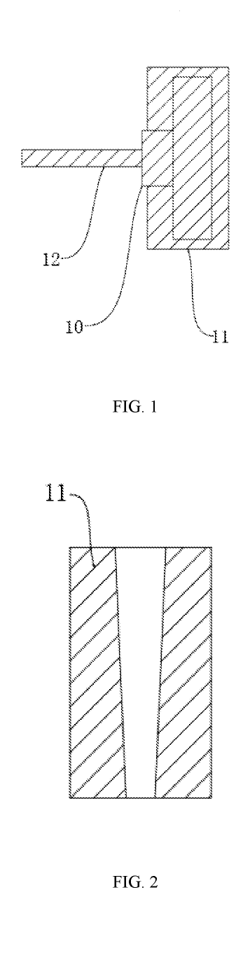

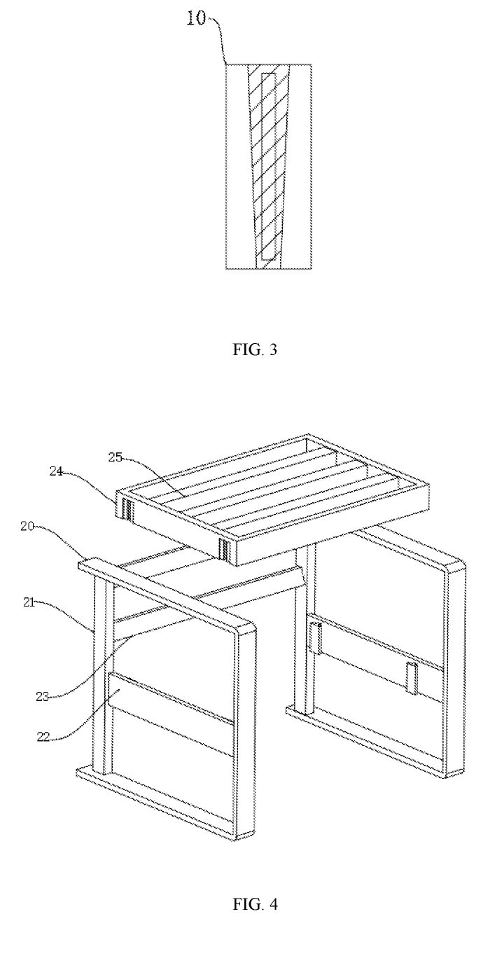

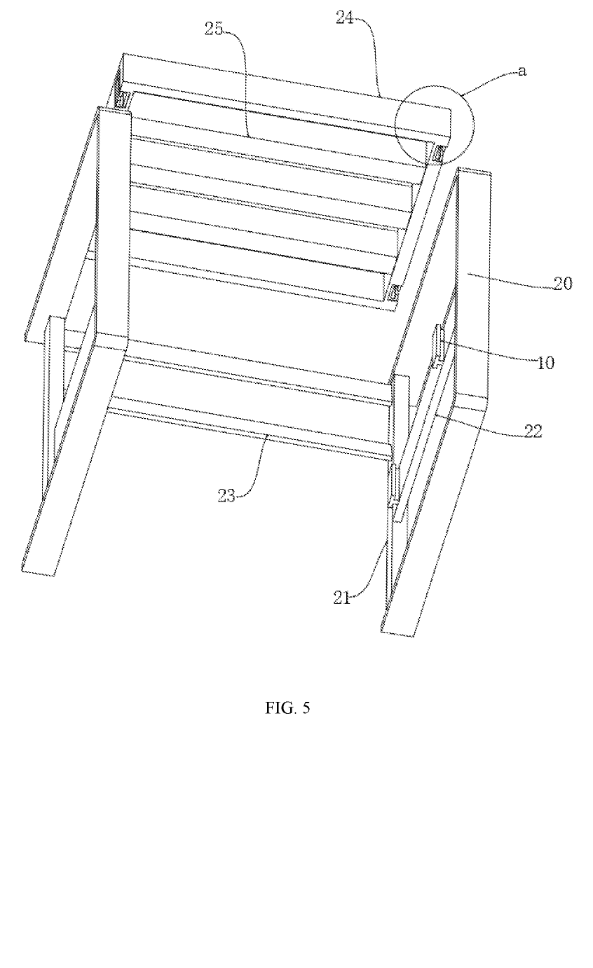

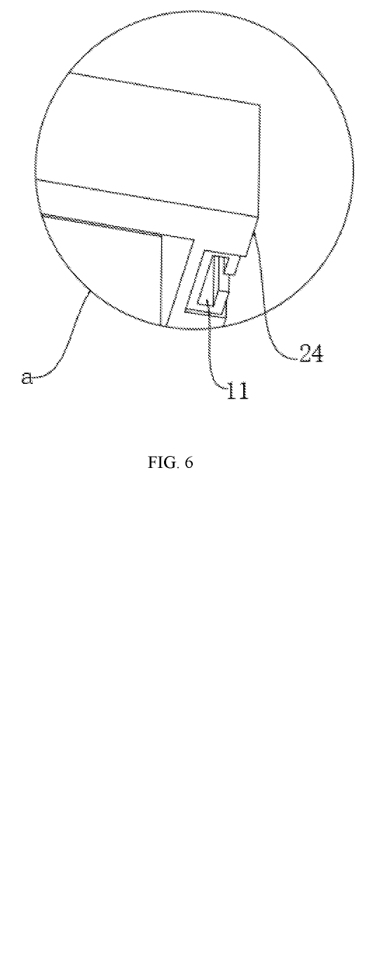

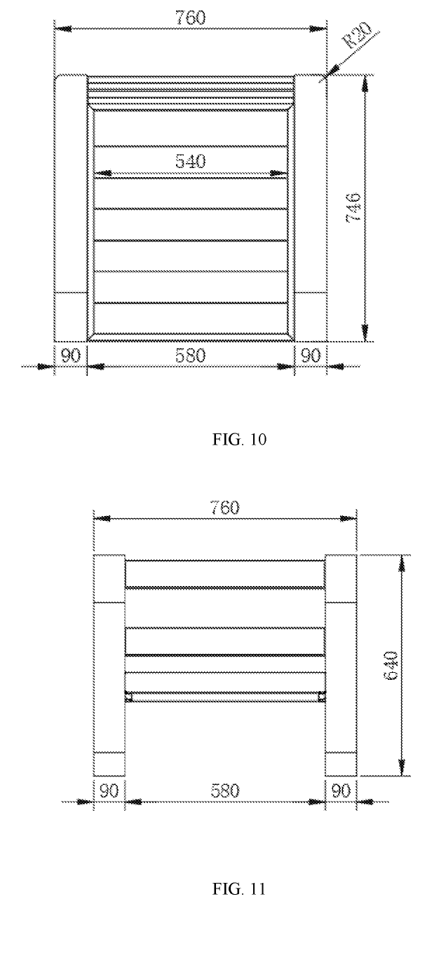

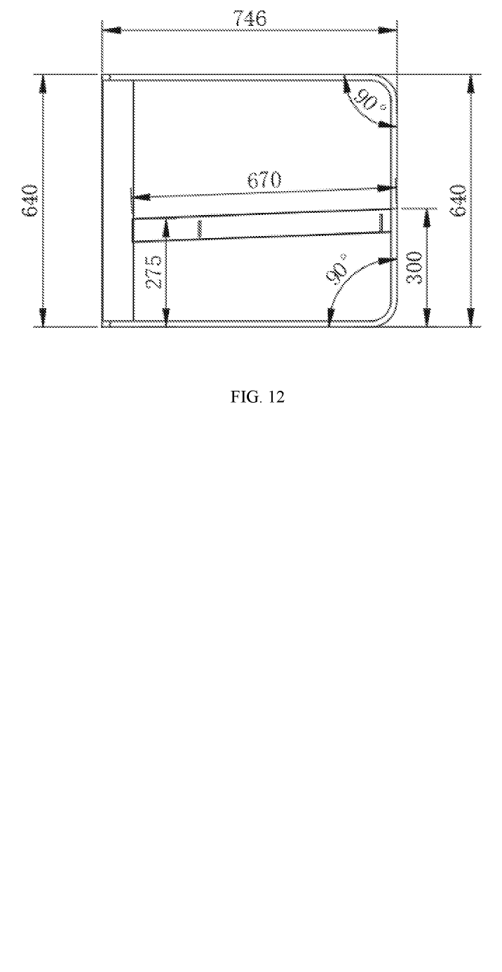

Referring to FIG. 1 to FIG. 12, a quick disassembly and assembly type connecting structure includes a seat, and the seat further includes first leg frames 20 and a first hip frame 24; a first leg vertical bar 21 is fixed to an inner side of the first leg frame 20; a first leg cross bar 22 is welded and fixed between the first leg vertical bar 21 and the first leg frame 20; a first backrest plate 23 is welded and fixed between the two adjacent first leg vertical bars 21; a quick-release pin head 10 is mounted on a surface of the first leg cross bar 22, and a mounting plate 12 is welded and fixed to an end of the quick-release pin head 10; and the mounting plate 12 is embedded in and welded and fixed to the first leg cross bar 22.

It needs to be further noted that: first hip cross plates 25 are fixed to an inner side of the first hip frame 24, quick-release pin seats 11 are embedded in and welded to both sides of the first hip frame 24, and the quick-release pin head 10 is slidably inserted in and docked with the quick-release pin seat 11.

### Embodiment II

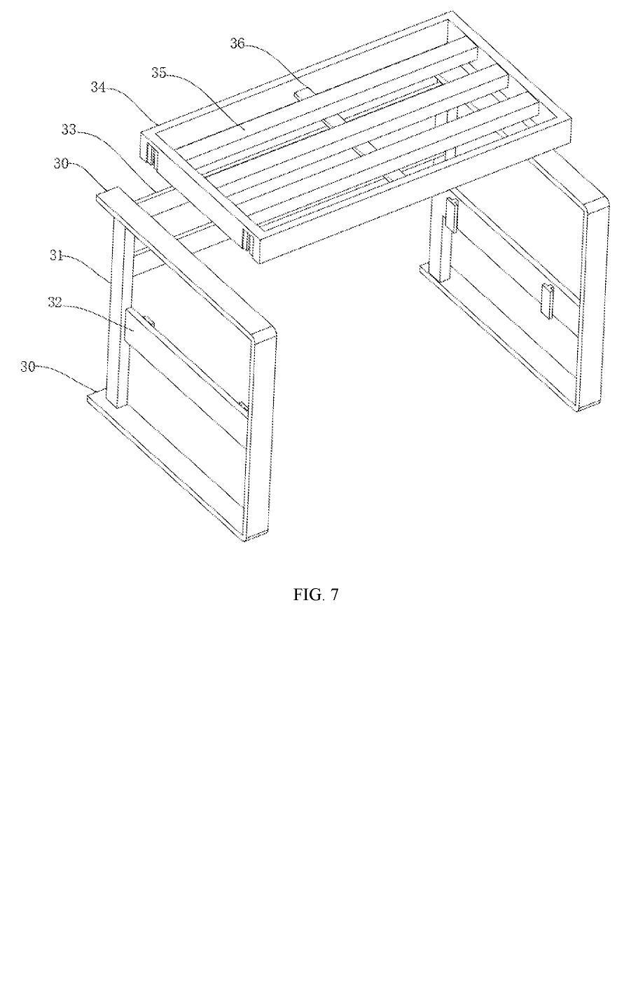

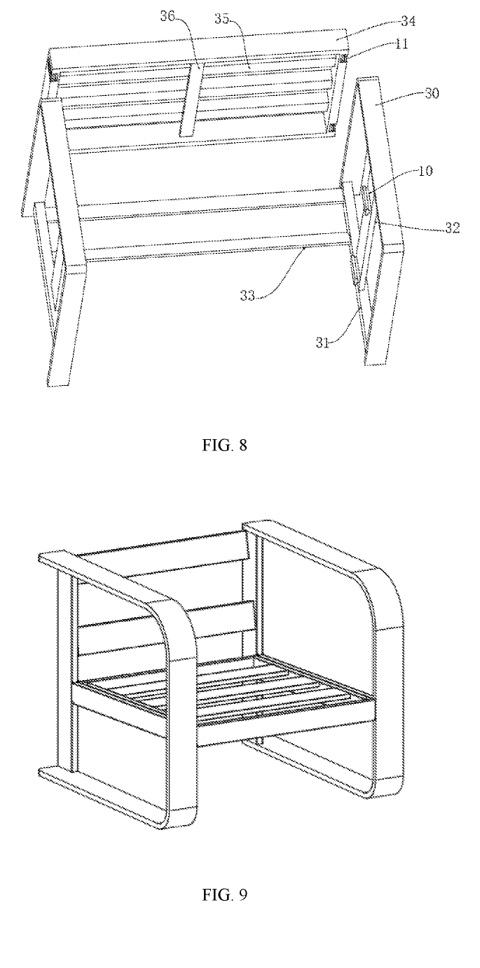

Referring to FIG. 1 to FIG. 3, FIG. 7, and FIG. 8, a quick disassembly and assembly type connecting structure includes a sofa, and the sofa further includes second leg frames 30 and a second hip frame 34; a second leg vertical bar 31 is fixed to an inner side of the second leg frame 30; a second leg cross bar 32 is welded and fixed between the second leg vertical bar 31 and the second leg frame 30; a second backrest plate 33 is welded and fixed between the two adjacent second leg vertical bars 31; a quick-release pin head 10 is mounted on a surface of the second leg cross bar 32, and a mounting plate 12 is welded and fixed to an end of the quick-release pin head 10; and the mounting plate 12 is embedded in and welded and fixed to the second leg cross bar 32.

It needs to be further noted that: second hip cross bars 35 are fixed to an inner side of the second hip frame 34, a hip longitudinal bar 36 is further fixed to the inner side of the second hip frame 34, and the hip longitudinal bar 36 is attached to the hip cross bars 35; and quick-release pin seats 11 are embedded in and welded to both sides of the second hip frame 34, and the quick-release pin head 10 is slidably inserted in and docked with the quick-release pin seat 11.

Working mode: After the quick-release pin head 10 is slidably inserted into the quick-release pin seat 11, flexible assembly is achieved; and since a notch of a slideway of the quick-release pin seat 11 is of a conical structure, during continuous sliding docking of the quick-release pin head 10, a wide part and a narrow part are docked, thereby achieving limiting and fastening, and ensuring stable mounting of the quick-release connecting structure.

What is described above is only preferred embodiments of the present disclosure, but the protection scope of the present disclosure is not limited thereto, and any equivalent substitution or improvement made by those skilled in the art within the technical scope disclosed in the present disclosure according to the technical solution and the inventive concept of the present disclosure shall fall within the protection scope of the present disclosure.

What is claimed is:

1. A quick disassembly and assembly type connecting structure, comprising a quick-release pin head (10) and a quick-release pin seat(11), wherein the quick-release pin head (10) and the quick-release pin seat (11) are slidably arranged, a cross section of a slideway of the quick-release pin seat (11) is of an inverted T-shaped structure, the quick-release pin head (10) is slidably in close fit with the slideway, and a mounting plate (12) is welded and fixed to an end of the quick-release pin head (11).

2. The quick disassembly and assembly type connecting structure according to claim 1, wherein the quick-release pin head (10) and the quick-release pin seat (11) and the mounting plate (12) are made of a stainless steel material.

3. The quick disassembly and assembly type connecting structure according to claim 1, wherein a vertical opening in a front side of the slideway of the quick-release pin seat (11) is in a shape of a conical structure.

4. The quick disassembly and assembly type connecting structure according to claim 1, wherein a position, fitting a vertical opening of the slideway, of the end of the quick-release pin head (10) is of a conical structure.
